(19) United States
(12) Patent Application Publication
(10) Pub. No.: US 2010/0065556 A1
(43) Pub. Date: Mar. 18, 2010

(54) Construct for Browning and Crisping a Food Item in a Microwave Oven

(76) Inventor: Lorin R. Cole, Larsen, WI (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/560,695

(22) Filed: Sep. 16, 2009

Related U.S. Application Data
(60) Provisional application No. 61/192,251, filed on Sep. 17, 2008.

(51) Int. Cl. H05B 6/80

(52) U.S. Cl. 219/730; 428/119

(57) ABSTRACT

A microwave heating construct comprises a base and a plurality of upstanding walls defining an interior space, a microwave energy interactive material overlying at least a portion of the base, and a line of disruption extending substantially across the base. The line of disruption defines a first section and a second section of the construct, each section of the construct being adapted to receive at least a portion of a food item.

### CROSS-REFERENCE TO RELATED APPLICATION

This application claims the benefit of U.S. Provisional Application No. 61/192,251, filed Sep. 17, 2008, which is incorporated by reference herein in its entirety.

### TECHNICAL FIELD

Constructs or apparatuses for heating or cooking a food item in a microwave oven are disclosed. In particular, this disclosure relates to various constructs for heating or cooking a food item in a microwave oven, where the food item has more than one item and/or surface intended to be browned and/or crisped.

### SUMMARY

This disclosure is directed generally to a construct or apparatus for preparing a food item in a microwave oven. The construct generally includes a heating surface capable of heating, browning, and/or crisping one or more components of a food item simultaneously. In one exemplary embodiment, the construct comprises a tray including a pair of sections that are capable of hinging towards one another along a line of disruption. The construct may be formed from a disposable material, for example, paperboard.

The construct may include a microwave energy interactive element that alters the effect of microwave energy on the adjacent food item. In one example, the microwave interactive element comprises a thin layer of microwave energy interactive material (generally less than about 100 angstroms in thickness, for example, from about 60 to about 100 angstroms in thickness, having an optical density of 0.15 to about 0.35 (e.g., from about 0.21 to about 0.28) that tends to absorb at least a portion of impinging microwave energy and convert it to thermal energy (i.e., heat) at the interface with the food item. Susceptor elements often are used to promote browning and/or crisping of the surface of a food item. However, other microwave energy interactive elements may be used.

The construct may be used to prepare various food items in a microwave oven, for example, sandwiches, savory or sweet pastries, breaded food items, or any other food item that desirably is heated, browned, and/or crisped.

Additional aspects, features, and advantages of the present invention will become apparent from the following description and accompanying figures.

### BRIEF DESCRIPTION OF THE DRAWINGS

The description refers to the accompanying drawings in which like reference characters refer to like parts throughout the several views, and in which:

FIG. 1A is a perspective view of an exemplary microwave heating construct according to various aspects of the disclosure, in a fully open configuration;

FIG. 1B is a perspective view of the microwave heating construct of FIG. 1A, in a partially closed configuration;

FIG. 1C is another perspective view of the microwave heating construct of FIG. 1A, in a partially closed configuration;

FIG. 1D is a perspective view of a portion of the microwave heating construct of FIGS. 1A-1C, separated into two parts;

FIG. 1E is a schematic top plan view of one side of a blank that may be used to form the microwave heating construct of FIGS. 1A-1C;

FIG. 1F is a perspective view of the construct formed from the blank of FIG. 1E; and

FIG. 2 is a schematic top plan view of one side of another exemplary blank that may be used to form a microwave heating construct.

### DESCRIPTION

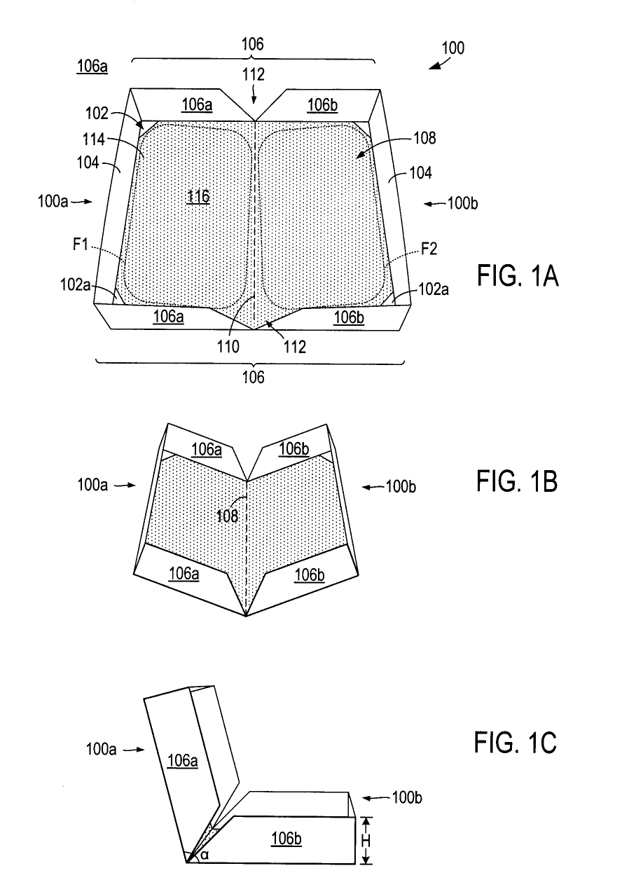

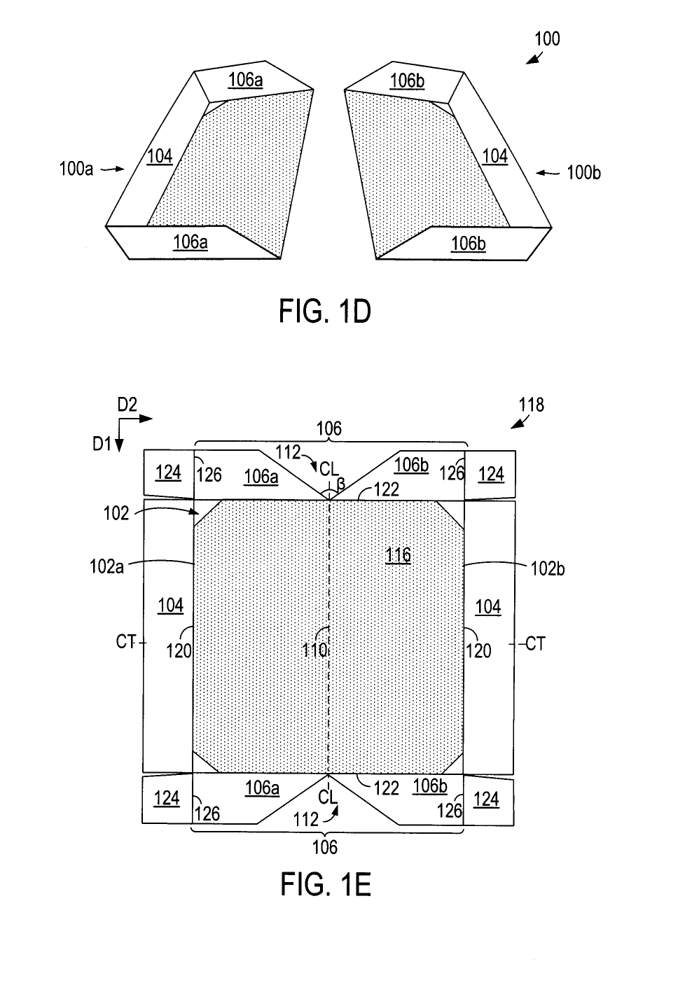

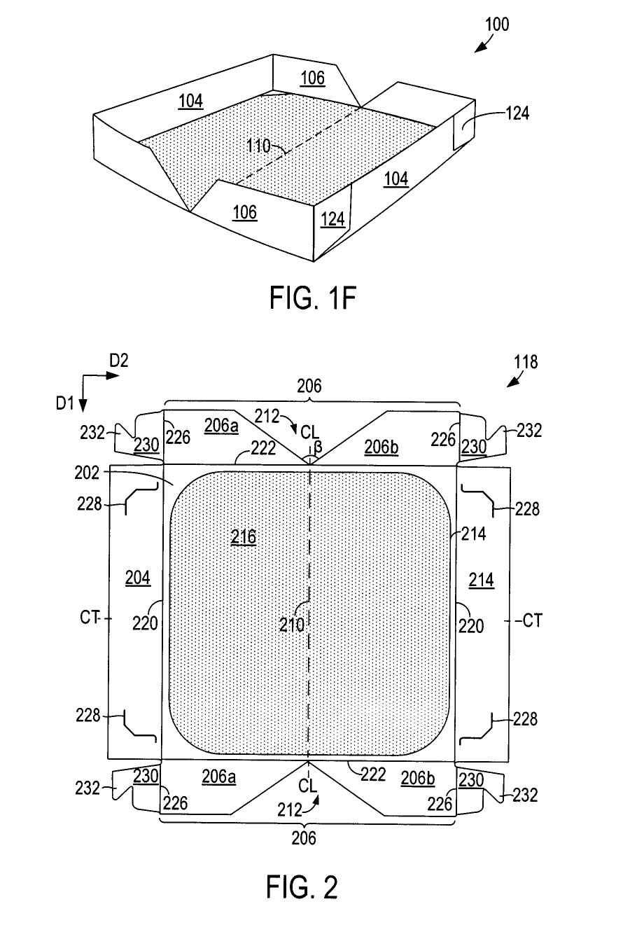

FIGS. 1A-1C schematically depict a microwave heating construct or apparatus 100 for heating, browning, and/or crisping a food item, for example, a sandwich, a breaded food item, or any other suitable food item. As shown in FIG. 1A, the construct generally comprises a tray 100 including a substantially planar base 102, a first pair of walls 104 opposite one another and a second pair of walls 106 opposite one another. The walls 104, 106 extend upwardly from a peripheral edge (e.g., outermost edge) of the base 102. The base 102 and walls 104, 106 define an interior space 108 for receiving one or more food items.

A line of disruption 110 extends substantially across the base 102 between the second pair of opposed walls 106. The line of disruption 110 defines a first section or portion 100a and a second section or portion 100b of the tray or construct 100, and a corresponding first section or portion 102a and second section or portion 102b of the base 102.

Each wall of the second pair of walls 106 includes a cutout or notch 112 substantially centered along the line of disruption 110. In this example, the notch 112 has a substantially triangular (e.g., inverted triangle) shape. However, other shapes are contemplated. The notch 112 divides each wall 106 into two sections 106a, 106b, with each section 106a, 106b of the wall being chamfered adjacent to the line of disruption 110, such that the height H (FIG. 1C) of the chamfered portion of the wall decreases in a direction towards the line of disruption 110.

As shown in FIGS. 1B and 1C, the line of disruption 110 may serve as a line of hinging (or hinge line) that allows the tray sections 100a, 100b to pivot toward one another (or to allow one section to pivot towards the other) to bring the construct 100 into a partially or substantially closed configuration. In this example, the chamfered portions of the walls 106 allow the sections 100a, 100b of the construct 100 to be brought into a substantially right (i.e., perpendicular) configuration without the respective wall sections 106 interfering with or engaging one another, such that an angle a (FIG. 1C) between the sections 100a, 100b of the construct 100 may be about 90°. However, other notch shapes may be used to allow further hinging, such that the angle a between construct portions 100a, 100b may be less than 90°.

If desired, a microwave energy interactive element 114 (shown schematically with stippling in FIGS. 1A-1D), for example, a susceptor, may overlie at least a portion of an interior side of the construct 100. The susceptor 114 may be supported on a polymer film 116 that at least partially defines an interior, food-contacting surface of the construct 100. In this example, the susceptor 114 substantially overlies the entire base 102 except for the corners, such that the susceptor 114 has a generally octagonal shape. However, other configurations of susceptors and/or other microwave energy interactive elements may be used, as will be discussed further below.

There are numerous possible ways to use the construct 100. In one example, the food item has a pair of opposite sides, each of which is desirably browned and/or crisped. The food item may be separated into first and second parts F1, F2 (shown schematically with dashed lines in FIG. 1A), with the side of each part F1, F2 to be browned and/or crisped being positioned on the base 102 adjacent to the susceptor 114. By way of example, and not limitation, the food item may be a sandwich including two pieces of bread and a filling. The sandwich may be separated into a top portion F1 and bottom portion F2, each including a piece of bread, and placed on the first and second sections 102a, 102b of the base, and heated in an “open face” configuration, such that one side of each piece of bread is positioned adjacent to the susceptor 114.

Upon sufficient exposure to microwave energy, the susceptor 114 converts at least a portion of the microwave energy into thermal energy (i.e., heat), which then may be transferred to the adjacent food item to heat, brown, and/or crisp the surface of the food item (e.g., the bread).

When the heating cycle is complete, the food item may be re-assembled if needed or desired. For example, where the food item is heated in an open face configuration as described above, the construct 100 may be brought into a somewhat closed position by pivoting either or both sections 100a, 100b of the construct to cause the components of the food item (e.g., the sandwich) to be brought towards one another. The components then may be stacked on top of one another. Alternatively, the various components may be manually assembled to form a double faced sandwich.

If desired, the construct 100 may be separated into two pieces (FIG. 1D) by tearing along the line of disruption (e.g., tear line) 110. One or both pieces may serve as a container for holding the food item as it is consumed. In this example, each section of the tray is substantially equal in size. However, other configurations are contemplated by the disclosure. By way of example and not limitation, one of the portions may be sized to have a larger base panel and/or higher side walls to better contain the assembled food item.

In another example, both the bread and the filling of a sandwich are desirably browned and/or crisped. The filling, for example, a breaded meat item, may be placed on one section of the tray, while the bread is placed on the other. If desired, the user may be instructed to invert or “flip” one or both items during heating to brown and/or crisp the opposite side of the respective item. Additionally or alternatively, where the sandwich includes two pieces of bread (i.e., the sandwich is a double faced sandwich), the user may be instructed to replace the browned and/or crisped bread with the other piece, so that both pieces may be browned and/or crisped. Numerous other possibilities are contemplated.

FIG. 1E depicts a schematic top plan view of one side of an exemplary blank 118 that may be used to form the construct 100 of FIGS. 1A-1D. The blank 118 includes a plurality of panels joined along lines of weakening or disruption, for example, fold lines, tear lines, score lines, or any other lines of weakening or disruption, or any combination thereof. The blank 118 and each of the various panels generally has a first dimension, for example, a length, extending in a first direction, for example, a longitudinal direction, D1, and a second dimension, for example, a width, extending in a second direction, for example, a transverse direction, D2. It will be understood that such designations are made only for convenience and do not necessarily refer to or limit the manner in which the blank is manufactured or erected into the construct. The blank 118 may be symmetric or nearly symmetric about a transverse centerline CT and along a longitudinal centerline CL. Therefore, certain elements in the drawing figures may have similar or identical reference numerals to reflect the whole or partial symmetry.

As shown in FIG. 1E, the blank 118 includes a main panel 102 divided by a longitudinal line of disruption 110 into a first section or portion 102a and a second section or portion 102b. A pair of opposed side panels 104 is joined to the main panel 102 along respective longitudinal fold lines 120.

Likewise, a pair of opposed end panels 106 is joined to the main panel 102 along respective transverse fold lines 122, which may be substantially perpendicular to fold lines 120. The end panels 106 are generally rectangular shaped with a V-shaped (i.e., substantially triangular) notch or cutout 112 substantially centered along the longitudinal tear line 110. Each end panel 106 has a first section or portion 106a joined to the first section 102a of the main panel 102 and a second section or portion 106b joined to the second section 102b of the main panel 102, with the respective adjacent portions 106a, 106b being separated from one another by the notch 112. In each of various examples, an angle β between the notched edges of end panel portions 106a, 106b may be at least about 30°, at least about 40°, at least about 50°, at least about 60°, at least about 70°, at least about 80°, at least about 90°, at least about 100°, at least about 110°, at least about 120°, at least about 130°, at least about 140°, at least about 150°, at least about 160°, or at least about 170°. In one particular example, the edges are chamfered, such that the angle β is about 90°.

A pair of end flaps 124 is joined to the opposite transverse ends of each end panel 106 along respective longitudinal fold lines 126.

A microwave energy interactive element 114 (shown schematically with stippling in FIG. 1E), for example, a susceptor, may overlie all or a portion of any of the various panels of the blank 118. In this example, the microwave energy interactive element 114 has a substantially rectangular or square shape with chamfered corners. However, other configurations are contemplated. For example, in one exemplary embodiment, the susceptor overlies substantially all of one side of the blank 118. In still another exemplary embodiment, the susceptor overlies substantially all of one side of the blank, except the end flaps 124.

To form the construct 100 from the blank 118 according to one exemplary method, the end flaps 124 may be folded inwardly toward the respective adjacent end panel 106 along longitudinal fold lines 126. The side panels 104 and end panels 106 may be folded along respective fold lines 120, 122 into a substantially upright position to form the walls 104, 106 of the construct or tray 100 (FIG. 1A). The end flaps 124 may be overlapped with and joined to the respectively adjacent portion of the side panels 104 to form the construct 100, as shown in FIG. 1F. The end flaps 124 may be joined to the side panels 104 in any suitable manner, for example, using adhesive bonding, mechanical fastening, thermal bonding, or any suitable combination thereof Where adhesive bonding is used, the end flaps 124 may be referred to as “glue flaps”.

The construct may have any suitable dimensions, as needed for a particular microwave heating application. The particular dimensions may depend on the type of food item being heated, the desired heating time, the desired degree of browning and/or crisping, or any other suitable criteria.

FIG. 2 schematically depicts an exemplary variation of the blank 118 of FIG. 1E. The blank 218 of FIG. 2 includes features that are similar to the blank 118 shown in FIG. 1E, except for variations noted and variations that will be understood by those of skill in the art. For simplicity, the reference numerals of similar features are preceded in the figures with a “2” instead of a “1”.

In this example, the blank 218 is similar to the blank 118 of FIG. 1E, except that each side panel 204 includes a pair of somewhat S-shaped or zigzag shaped slits 228 proximate to the opposite longitudinal ends of the respective panel 204. Additionally, end flaps 124 are replaced with locking flaps 230, each of which includes a locking projection 232 adapted to secure the respective locking flap 230 within the respectively adjacent receiving slit 228 in the side panel 204.

Further, in this example, the microwave energy interactive element 214, for example, the susceptor 214, has a substantially rectangular or square shape with rounded corners. Still other configurations are contemplated.

A construct formed from the blank 218 may be used in the manner described in connection with the construct 100 of FIGS. 1A-1D.

Numerous other microwave heating constructs are encompassed by the disclosure. Any of such constructs may be formed from various materials, provided that the materials are substantially resistant to softening, scorching, combusting, or degrading at typical microwave oven heating temperatures, for example, at from about 250° F. to about 425° F. The materials may include microwave energy interactive materials, for example, those used to form susceptors (e.g., susceptors 114, 214) and other microwave energy interactive elements, and microwave energy transparent or inactive materials, for example, those used to form the remainder of the construct.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

While susceptors are illustrated herein, the construct also may include a foil or high optical density evaporated material having a thickness sufficient to reflect a substantial portion of impinging microwave energy. Such elements are typically formed from a conductive, reflective metal or metal alloy, for example, aluminum, copper, or stainless steel, in the form of a solid “patch” generally having a thickness of from about 0.000285 inches to about 0.05 inches, for example, from about 0.0003 inches to about 0.03 inches. Other such elements may have a thickness of from about 0.00035 inches to about 0.020 inches, for example, 0.016 inches.

Larger microwave energy reflecting elements may be used where the food item is prone to scorching or drying out during heating. Smaller microwave energy reflecting elements may be used to diffuse or lessen the intensity of microwave energy. A plurality of smaller microwave energy reflecting elements also may be arranged to form a microwave energy directing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The breaks or apertures may extend through the entire structure, or only through one or more layers. The number, shape, size, and positioning of such breaks or apertures may vary for a particular application depending on the type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in one or more layers or materials used to form the construct, or may be a non-physical “aperture”. A non-physical aperture is a microwave energy transparent area that allows microwave energy to pass through the structure without an actual void or hole cut through the structure. Such areas may be formed by simply not applying a microwave energy interactive material to the particular area, or by removing microwave energy interactive material in the particular area, or by chemically and/or mechanically deactivating the microwave energy interactive material in the particular area. While both physical and non-physical apertures allow the food item to be heated directly by the microwave energy, a physical aperture also provides a venting function to allow steam or other vapors to escape from the interior of the construct.

The arrangement of microwave energy interactive and microwave energy transparent areas may be selected to provide various levels of heating, as needed or desired for a particular application. For example, where greater heating is desired, the total inactive area may be increased. In doing so, more microwave energy is transmitted to the food item. Alternatively, by decreasing the total inactive area, more microwave energy is absorbed by the microwave energy interactive areas, converted into thermal energy, and transmitted to the surface of the food item to enhance browning and/or crisping.

It will be understood that the aperture may be a physical aperture or void in one or more layers or materials used to form the construct, or may be a non-physical “aperture” (not shown). A non-physical aperture is a microwave energy transparent area that allows microwave energy to pass through the structure without an actual void or hole cut through the structure. Such areas may be formed by simply not applying microwave energy interactive material to the particular area, or by removing microwave energy interactive material in the particular area, or by mechanically deactivating the particular area (rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors to escape from the interior of the construct.

The arrangement of microwave energy interactive and microwave energy transparent areas may be selected to provide various levels of heating, as needed or desired for a particular application. For example, where greater heating is desired, the total inactive (i.e., microwave energy transparent) area may be increased. In doing so, more microwave energy is transmitted to the food item. Alternatively, by decreasing the total inactive area, more microwave energy is absorbed by the microwave energy interactive areas, converted into thermal energy, and transmitted to the surface of the food item to enhance heating, browning, and/or crisping.

In some instances, it may be beneficial to create one or more discontinuities or inactive regions to prevent overheating or charring of the construct. By way of example, and not limitation, in the construct 100 illustrated in FIG. 1A, the end flaps 124 are in an overlapping relationship with the side panels 104. When exposed to microwave energy, the concentration of heat generated by the overlapped panels may be sufficient to cause the underlying support, in this case, paperboard, to become scorched. As such, the overlapping portions of one or both of panels or flaps 104, 124 may be designed to be microwave energy transparent, for example, by forming these areas of the blank 118 or construct 100 without a microwave energy interactive material, by removing any microwave energy interactive material that has been applied, or by deactivating the microwave energy interactive material in these areas, as discussed above.

Further still, one or more panels, portions of panels, or portions of the construct may be designed to be microwave energy inactive to ensure that the microwave energy is focused efficiently on the areas to be heated, browned, and/or crisped, rather than being lost to portions of the food item not intended to be browned and/or crisped or to the heating environment. This may be achieved using any suitable technique, such as those described above. By way of example, and not limitation, in the example illustrated in FIG. 2, the corners and peripheral margin of the base panel 102, and the entirety of the side panels 104, end panels 106, and locking flaps 136 may be microwave energy inactive where such areas are not likely to be in proximate or intimate contact with the primary areas of the food item intended to be browned and/or crisped.

As stated above, the microwave energy interactive element may be supported on a microwave inactive or transparent substrate 116 (FIG. 1A), for example, a polymer film or other suitable polymeric material, for ease of handling and/or to prevent contact between the microwave energy interactive material and the food item. The outermost surface of the polymer film may define at least a portion of the food-contacting surface of the package (e.g., the surface of respective polymer film 116). Examples of polymer films that may be suitable include, but are not limited to, polyolefins, polyesters, polyamides, polyimides, polysulfones, polyether ketones, cellophanes, or any combination thereof In one particular example, the polymer film comprises polyethylene terephthalate. The thickness of the film generally may be from about 35 gauge to about 10 mil. In each of various examples, the thickness of the film may be from about 40 to about 80 gauge, from about 45 to about 50 gauge, about 48 gauge, or any other suitable thickness. Other non-conducting substrate materials such as paper and paper laminates, metal oxides, silicates, cellulosics, or any combination thereof, also may be used.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item. For example, the microwave energy interactive material may be provided as a continuous or discontinuous layer or coating including circles, loops, hexagons, islands, squares, rectangles, octagons, and so forth.

Various materials may serve as the base material for the construct 100. For example, the construct may be formed at least partially from a polymer or polymeric material. As another example, all or a portion the construct may be formed from a paper or paperboard material. In one example, the paper has a basis weight of from about 15 to about 60 lbs/ream (lb/3000 sq. ft.), for example, from about 20 to about 40 lbs/ream. In another example, the paper has a basis weight of about 25 lbs/ream. In another example, the paperboard having a basis weight of from about 60 to about 330 lbs/ream, for example, from about 155 to about 265 lbs/ream. In one particular example, the paperboard has a basis weight of about 175 lbs/ream. The paperboard generally may have a thickness of from about 6 to about 30 mils, for example, from about 14 to about 24 mils. In one particular example, the paperboard has a thickness of about 16 mils. Any suitable paperboard may be used, for example, a solid bleached or solid unbleached sulfate board, such as SUS® board, commercially available from Graphic Packaging International.

The package may be formed according to numerous processes known to those in the art, including using adhesive bonding, thermal bonding, ultrasonic bonding, mechanical stitching, or any other suitable process. Any of the various components used to form the package may be provided as a sheet of material, a roll of material, or a die cut material in the shape of the package to be formed (e.g., a blank).

It will be understood that with some combinations of elements and materials, the microwave energy interactive element may have a grey or silver color that is visually distinguishable from the substrate or the support. However, in some instances, it may be desirable to provide a package having a uniform color and/or appearance. Such a package may be more aesthetically pleasing to a consumer, particularly when the consumer is accustomed to packages or containers having certain visual attributes, for example, a solid color, a particular pattern, and so on. Thus, for example, the present disclosure contemplates using a silver or grey toned adhesive to join the microwave energy interactive element to the support, using a silver or grey toned support to mask the presence of the silver or grey toned microwave energy interactive element, using a dark toned substrate, for example, a black toned substrate, to conceal the presence of the silver or grey toned microwave energy interactive element, overprinting the metallized side of the polymer film with a silver or grey toned ink to obscure the color variation, printing the non-metallized side of the polymer film with a silver or grey ink or other concealing color in a suitable pattern or as a solid color layer to mask or conceal the presence of the microwave energy interactive element, or any other suitable technique or combination of techniques.

Although certain embodiments of this invention have been described with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is not intended nor is to be construed to limit the present invention or otherwise to exclude any such other embodiments, adaptations, variations, modifications, and equivalent arrangements of the present invention.

What is claimed is:

1. A microwave heating construct, comprising:
a base and a plurality of upstanding walls defining an interior space for receiving a food item;
a microwave energy interactive material overlying at least a portion of the base; and
a line of disruption extending substantially across the base, the line of disruption defining a first section and a second section of the construct, each section of the construct including a portion of the base and at least one wall of the plurality of upstanding walls.

2. The construct of claim 1, wherein the walls of at least one of the first section and the second section include a chamfered portion adjacent to the line of disruption.

3. The construct of claim 1, wherein the walls of at least one of the first section and the second section include a portion that decreases in height towards the line of disruption.

4. The construct of claim 1, wherein the line of disruption substantially bisects the base.

5. The construct of claim 1, wherein the line of disruption serves as a hinge for pivoting the first section towards the second section.

6. The construct of claim 1, wherein
the line of disruption is a tear line; and
the first section and the second section are adapted to be separated from one another along the tear line.

7. The construct of claim 1, wherein the microwave energy interactive material further overlies at least a portion of the walls on a side of the walls facing the interior space.

8. The construct of claim 1, wherein the microwave energy interactive material has an optical density of from about 0.21 to about 0.28.

9. The construct of claim 1, wherein the microwave energy interactive material is operative for converting at least a portion of microwave energy to thermal energy.

10. The construct of claim 1, wherein the microwave energy interactive material comprises aluminum.

11. A method of heating, browning, and/or crisping a food item in a microwave oven, comprising:
providing a food item having a first surface and a second surface to be browned and/or crisped, the first surface and the second surface being opposite one other;
providing a microwave heating construct including
a base and a plurality of upstanding walls defining an interior space,
a microwave energy interactive material overlying at least a portion of the base, the microwave energy interactive material being operative for converting microwave energy into thermal energy, and
a line of disruption extending substantially across the base, the line of disruption defining a first section and a second section of the construct; and
positioning a food item on the base such that the first surface of the food item is seated on the first section of the construct and the second surface of the food item is positioned on the second section of the construct.

12. The method of claim 11, further comprising separating the food item into a first portion and a second portion, the first portion including the first surface and the second portion including the second surface.

13. The method of claim 12, wherein
the first portion of the food item is a top portion of the food item, and
the second portion of the food item is a bottom portion of the food item.

14. The method of claim 12, wherein
the first portion of the food item is an outer portion of the food item, and
the second portion of the food item is a filling.

15. The method of claim 12, further comprising exposing the food item on the construct to microwave energy.

16. The method of claim 15, wherein the microwave energy interactive material converts at least a portion of the microwave energy into thermal energy to brown and/or crisp the upper surface and lower surface of the food item.

17. The method of claim 12, further comprising pivoting at least one of the first section and the second section along the line of disruption to bring the first portion and the second portion of the food item together.

18. The method of claim 17, wherein the walls of at least one of the first section and the second section include a chamfered portion adjacent to the line of disruption.

19. The method of claim 12, wherein the line of disruption is a tear line, and the method further comprises separating the first section and the second section from one another along the tear line.

20. The method of claim 19, further comprising using at least one of the first section and the second section as a container for the food item.

21. A blank for forming a microwave heating construct, comprising:
a plurality of adjoined panels, each of the adjoined panels having a first dimension extending in a first direction and a second dimension extending in a second direction substantially perpendicular to the first direction, the plurality of adjoined panels including
a first panel, the first panel including a line of disruption extending in the first direction, the line of disruption extending substantially between a pair of opposite edges of the first panel extending in the second direction, and
a second panel and a third panel foldably respectively joined to the opposite edges of the first panel, each of the second panel and the third panel including a notch adjacent to the line of disruption; and
a microwave energy interactive material joined to the first panel, the microwave energy interactive material being operative for converting at least a portion of microwave energy into thermal energy.

22. The blank of claim 21, wherein the notch is substantially triangular in shape, such that the notch defines a pair of chamfered edges of the respective panel adjacent to the line of disruption.
